(19) United States
(12) Patent Application Publication
(10) Pub. No.: US 2025/0214847 A1
(43) Pub. Date: Jul. 3, 2025

(54) PROCESS FOR PRODUCING POROUS SPHERICAL SILICA GEL PARTICLES

(71) Applicant: W.R. Grace & Co.-CONN., Columbia, MD (US)

(72) Inventors: Linping Xu, Clarksville, MD (US); Dave Chapman, Mount Airy, MD (US); Li Zhang, Panorama City, CA (US); Michael Baptiste, Jr., Laurel, MD (US); Jamin L. Krinsky, Laurel, MD (US); John H. Hain, Jr., Woodstock, MD (US)

(21) Appl. No.: 18/847,369

(22) PCT Filed: Mar. 15, 2023
(86) PCT No.: PCT/US2023/064484

§ 371 Date: Sep. 16, 2024

Related U.S. Application Data
(60) Provisional application No. 63/320,600, filed on Mar. 16, 2022.

(51) Int. Cl. C01B 33/16

(52) U.S. Cl. CPC C01B 33/166; C01P 2002/02; C01P 2004/32; C01P 2004/54; C01P 2004/61; C01P 2006/12; C01P 2006/14; C01P 2006/16

(57) ABSTRACT

A process for forming a porous spherical silica material is provided. The process comprises mixing an alkali silicate with a mineral acid at pH and temperature sufficient to form a silica sol, mixing the silica sol with an oil and a surfactant to form a water-in-oil type emulsion, adding an alkaline solution to the emulsion to form a gel, adding a demulsifying agent and heating to a temperature of from about 60°° C. to about 90° C., and filtering, washing, optionally aging, and drying to obtain the porous spherical silica gel particles.

### CROSS-REFERENCE TO RELATED APPLICATIONS

This application claims the benefit of priority to U.S. Provisional Application No. 63/320,600, filed on Mar. 16, 2022, the contents of which are incorporated by reference herein in their entirety.

### BACKGROUND

Porous spherical silica particles are used in a wide variety of applications. For example, they can be used as fillers for films and resins, as carriers or supports for various catalysts, as fillers for cosmetics, as a packing material for chromatography, as drying agents, and for other purposes. The requirements for the physical properties of the silica particles, such as particle size, particle shape, particle size distribution, pore size, pore volume, and surface area can differ by application.

Various processes for the production of porous spherical silica particles are known in the art. For example, in some processes, an aqueous sodium silicate solution or an alkyl silicate is emulsified in a solvent followed by gelation. In other processes, an aqueous sodium silicate solution or an alkyl silicate is gelled, followed by emulsification in a solvent and granulation. Further, in other processes, a silica sol or alkali silicate is spray dried to form porous spherical particles. Furthermore, some processes involve wet grinding a hydrogel followed by spray drying. However, there is still a need for a simple, economical process that produces porous spherical silica particles in which the pore size, pore volume, and particle size can be reliably controlled.

### SUMMARY

A process for forming a porous spherical silica material is provided. The process comprises mixing an alkali silicate with a mineral acid to form a silica sol, mixing the silica sol with an oil and a surfactant to form an emulsion, adding an alkaline solution to the emulsion to form a gel, adding a demulsifying agent and filtering to obtain the silica gel particles.

The silica material formed by the process can comprise a plurality of porous spherical silica gel particles. Each particle can comprise a rigid network of amorphous silica. The particles can have an average aspect ratio of about 1.2 or less, an average pore volume of greater than about 0.3 cc/g, an average surface area of at least about 200 m²/g; and a median particle size of about 1 μm or greater.

Other features and aspects of the present disclosure are discussed in greater detail below.

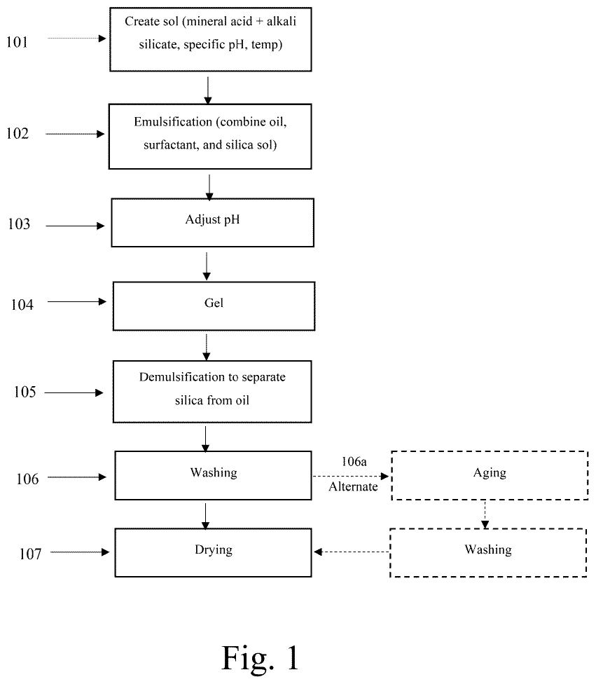

FIG. 1 shows a process flow diagram of a production process according to the present disclosure.

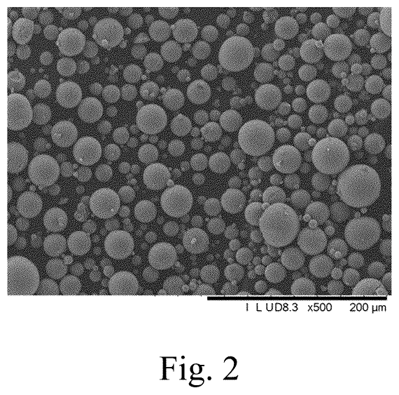

FIG. 2 shows an SEM image of the silica particles produced in Example 1.

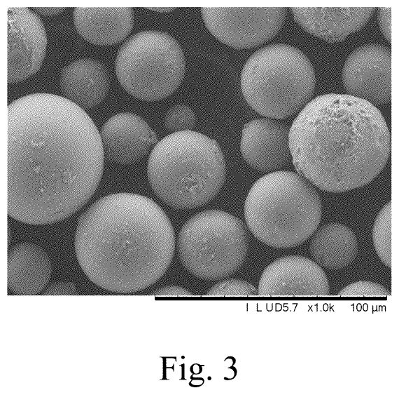

FIG. 3 shows an SEM image of the silica particles produced in Example 2.

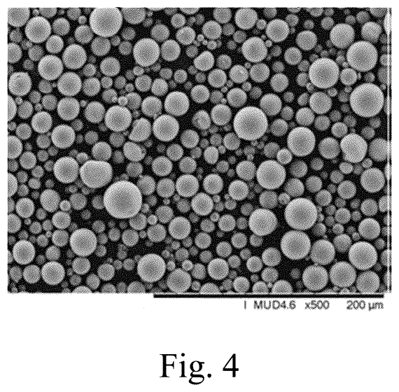

FIG. 4 shows an SEM image of the silica particles produced in Example 3.

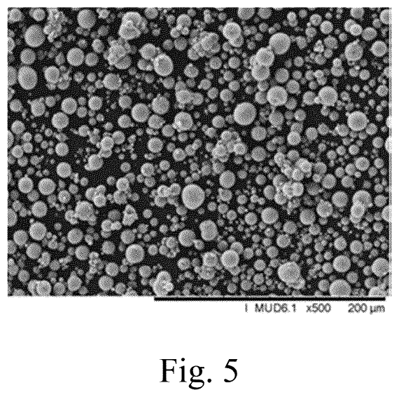

FIG. 5 shows an SEM image of the silica particles produced in Example 4.

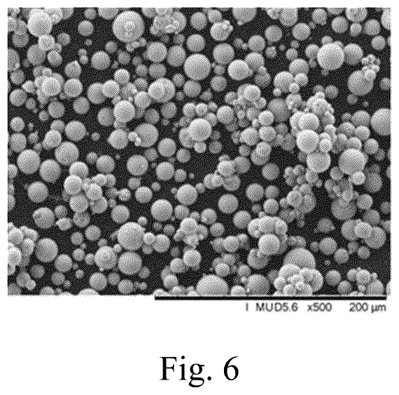

FIG. 6 shows an SEM image of the silica particles produced in Example 5.

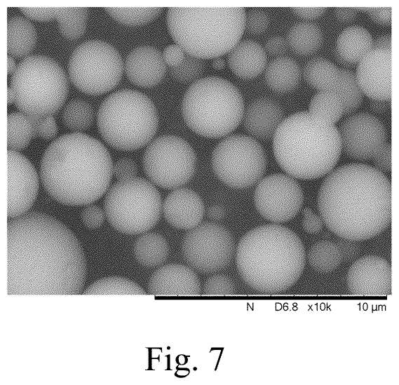

FIG. 7 shows an SEM image of the silica particles produced in Example 6.

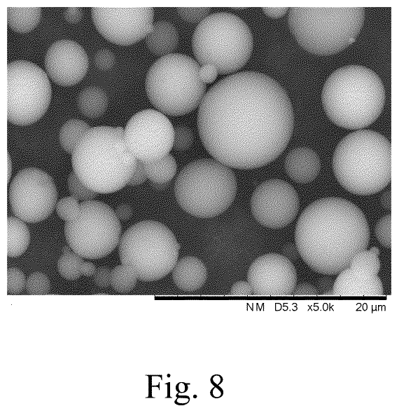

FIG. 8 shows an SEM image of the silica particles produced in Example 7.

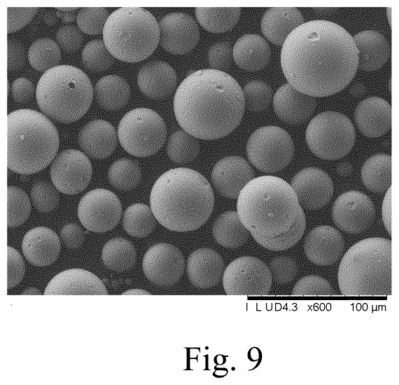

FIG. 9 shows an SEM image of the silica particles produced in Example 8.

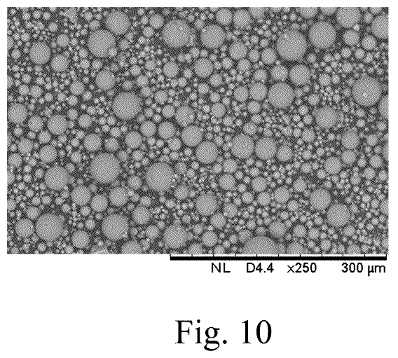

FIG. 10 shows an SEM image of the silica particles produced in Example 9.

### DETAILED DESCRIPTION

Before describing several exemplary embodiments, it is to be understood that the invention is not limited to the details of construction or process steps set forth in the following description. The invention is capable of other embodiments and of being practiced or being carried out in various ways.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

In general, the present disclosure is directed to a process for forming single gel porous silica particles via an emulsion process. The process generally comprises preparing a silica sol by mixing an alkali silicate with an acid at a specific pH and temperature and then mixing the sol with oil and a surfactant to generate a water-in-oil type emulsion. The term “water-in-oil type emulsion” is used herein to indicate an emulsion wherein oil is the continuous phase and water is the dispersed phase. It should be understood the “water” as used in the term “water-in-oil type emulsion” encompasses aqueous silica sol. The pH may then be adjusted by adding a basic compound into the emulsion to control the gelling process within the emulsion and the eventual pore structure. It was discovered that particle size, particle size distribution, pore volume, pore size and surface area can be reliably controlled by manipulating certain aspects of the emulsion process. Additionally, the process forms spherical, single gel particles which exhibit various advantages over particles formed by conventional processes, such as those formed by a spray drying agglomeration process.

For example, if used as a catalyst support, catalysts containing single gel support particles tend to perform better in olefin polymerization processes than catalysts containing agglomerated support particles. As used herein, single gel particles refer to particles that are not formed from agglomerates of smaller particles. Agglomerates refer to products that combine particles which are held together by a variety of physical-chemical forces. More specifically, agglomerates are composed of a plurality of contiguous, constituent primary particles joined and connected at their points of contact. In contrast to agglomerates, a single gel particle cannot be separated into smaller particles without fracturing the particle.

The process is also suitable for forming gel particles for various applications, including for example, as a catalyst support, chromatographic media, plastic additives, personal care and cosmetics as the process is capable of producing particles having desired particle size and pore properties.

The process can be used to form particles having a relatively high surface area as determined by BET method using nitrogen adsorption as described herein below. For example, the average surface area of the particles can be about 200 m²/g or greater, in some embodiments about 300 m²/g or greater, in some embodiments about 400 m²/g or greater, in some embodiments about 500 m²/g or greater, in some embodiments about 600 m²/g or greater, and in some embodiments, about 700 m2/g or greater. The average surface area of the particles can be about 1000 m²/g or less, in some embodiments about 900 m²/g or less, in some embodiments about 800 m²/g or less, in some embodiments about 700 m²/g or less, and in some embodiments, about 500 m²/g or less.

Additionally, the process can be used to form particles having a relatively high pore volume, as measured by nitrogen pore volume as described herein below. For example, the average pore volume of the particles can be about 0.3 cc/g or greater, in some embodiments about 0.5 cc/g or greater, in some embodiments about 0.8 cc/g or greater, and in some embodiments, about 1.2 cc/g or greater. The pore volume can be about 2.5 cc/g or less, in some embodiments about 2.0 cc/g or less, in some embodiments about 1.5 cc/g or less, and in some embodiments, about 1 cc/g or less. In some embodiments the pore volume ranges from 0.3 to 2.5 cc/g, in some embodiments about 0.5 to 2 cc/g, and in some embodiments from about 0.8 to about 1.5 cc/g.

The process can produce particles with average pore diameters as measured by nitrogen porosimetry of about 30 Angstroms or greater, in some embodiments about 50 Angstroms or greater, in some embodiments about 70 Angstroms or greater, in some embodiments about 100 Angstroms or greater, and in some embodiments about 150 Angstroms or greater. The average pore diameter can be about 300 Angstroms or less, in some embodiments about 250 Angstroms or less, and in some embodiments, about 200 Angstroms or less.

Surface area is determined by BET nitrogen adsorption analysis after an activation of the samples under vacuum for 30 minutes at 400°° C. The surface area is calculated from multi-point values of the nitrogen volumetric uptake during the adsorption branch at low [P/Po=˜ 0.05 to 0.15] partial pressures. The adsorption branch of the isotherm is stopped at a partial pressure of P/Po=0.995 and then the descending branch of the isotherm is measured. Nitrogen pore volumes are calculated by applying the Gurvich rule at P/Po=0.995. Pore diameters are reported as calculated BJH desorption average diameter.

In the past, it has been difficult to produce spherical, single gel porous silica particles having both a high pore volume and a high surface area. However, in some embodiments, the process described herein can produce silica particles having an average pore volume of about 2.3 cc/g or greater and an average surface area greater than about 350 m²/g. For example, when used in catalyst applications, such a combination allows for high catalyst loading on the support and high catalytic activity during polymerization.

The process can produce porous silica particles with a median particle size (D50), as measured by Laser Diffraction method described herein below, of about 1 μm or greater, in some embodiments about 3 μm or greater, in some embodiments about 8 μm or greater, in some embodiments about 15 μm or greater, and in some embodiments, about 20 μm or greater. The average particle size can be about 50 μum or less, in some embodiments about 40 μm or less.

Regardless of their average size, the process can produce particles having a relatively narrow particle size distribution. The breadth of the particle size distribution can be measured as a distribution span, defined by the following equation:

$$Distribution Span = \frac{( {D}_{90} - {D}_{10}}{{D}_{50}} ,$$

wherein D₁₀, D₅₀, and D₉₀ represent the 10^{th}, 50^{th}, and 90^{th} percentile, respectively, of the particle size (diameter) distribution, i.e. a D₉₀ of 100 microns means that 90 volume % of the particles have diameters less than or equal to 100 microns. In this regard, the distribution span of the particles can be about 2.0 or less, in some embodiments about 1.5 or less, in some embodiments about 1.45 or less, in some embodiments about 1.4 or less, in some embodiments about 1.3 or less, and in some embodiments from about 0.9 to about 1.25.

The present inventors unexpectedly discovered that the emulsion process described herein can produce porous silica particles having the unique properties described above. Additionally, it was found that the particle size, particle size distribution, pore size, pore volume, and surface area of the particles can be controlled by manipulating certain aspects of the emulsion process.

In the water-in-oil type emulsion process, a silica sol is prepared by mixing an alkali silicate with an acid. The sol is then mixed with oil and a surfactant to generate an emulsion. In the emulsion formed during the process, the oil phase is continuous, and the sol forms stable spherical droplets dispersed in the oil phase. The pH can then be adjusted by adding a basic compound into the emulsion, which can help control the gelling process within the emulsion and the eventual pore structure.

The process will be described in more detail with reference to FIG. 1. First, in step 101, a silica sol is formed by combining a mineral acid and an alkali silicate. The alkali silicate can include sodium silicate, potassium silicate, lithium silicate, or the like. The alkali silicate is typically provided as an aqueous solution with a concentration from about 5 wt. % to about 50 wt. % (based on SiO₂ in the alkali silicate), such as from about 10 wt. % to about 35 wt. %. The mineral acid can be sulfuric acid, hydrochloric acid, nitric acid, or the like. In some embodiments, the alkali silicate is sodium silicate and the mineral acid is sulfuric acid. In other embodiments, the alkali silicate is sodium silicate and the mineral acid is hydrochloric acid. To form the sol, the alkali silicate can be added to a vessel containing the mineral acid. The flow rate is adjusted to obtain desired throughput on an industrial scale. For example, on a laboratory scale, the alkali silicate can be added to the mineral acid at a flow rate from about 1 ml/min to about 250 ml/min, such as from about 5 ml/min to about 200 ml/min, preferably from about 50 ml/min to about 200 ml/min. Alternatively, the alkali silicate and mineral acid can be combined at once by pouring one into the other. The concentration of the mineral acid is typically from about 10 wt. % to about 50 wt. %, in some embodiments from about 15 wt. % to about 40 wt. %, and in some embodiments, from about 18 wt. % to about 35 wt. %. The weight ratio of mineral acid to alkaline silicate preferably results in pH less than 7. The weight ratio of mineral acid to alkali silicate is generally from about 1:10 to about 2:1, in some embodiments from about 1:7 to about 1:1, and in some embodiments, from about 1:5 to about 1:2.

In some embodiments, the concentration and amounts of aqueous alkali silicate and mineral acid are selected in order to reach a specified pH value. For example, in some embodiments, the pH of the resulting mixture is controlled to remain below about 4, such as below about 3, such as below about 1.5. The pH of the resulting mixture is typically about 1 or greater.

During the sol formation step, the temperature should be controlled to a relatively low temperature. For example, in some embodiments, the temperature is controlled to be about 40° C. or less in some embodiments about 30° C. or less, and in some embodiments, about 20° C. or less.

To form the sol, the mineral acid and alkali silicate can be continuously mixed in the vessel using a mixer, e.g., an overhead mixer. The mixer can operate at any suitable speed for a time period sufficient to form a sol. For example, in some embodiments, the mixture can be mixed for a time period from about 2 min to about an hour, such as from about 5 min to about 45 min, such as from about 10 min to about 40 min.

After the sol is formed, it is pumped into or otherwise combined with an oil and a surfactant to form the water-in-oil emulsion in step 102. The oil and surfactant can be combined to form a surfactant/oil mixture and the mixture is added to the sol. The amount of surfactant can be controlled to form stable spherical silica sol droplets. In some embodiments the surfactant is present in the mixture in an amount ranging from about 3 wt. percent to about 25 wt. percent of the total surfactant/oil mixture. Preferably, the surfactant is present in the mixture in an amount ranging from about 5 wt. percent to about 15 wt. percent. Alternatively, the oil and surfactant are added individually to the sol in amounts sufficient to provide a surfactant/oil mixture having the above-described wt. percent.

The oil is not particularly limited other than that it should be nonreactive and immiscible with the aqueous alkali silicate and the mineral acid. Exemplary oils include n-octane, gasoline, kerosene, isoparaffinic hydrocarbon oils and the like, alicyclic hydrocarbons such as cyclononane, cyclodecane and the like, aromatic hydrocarbons such as toluene, xylene, ethylbenzene, tetralin and the like, and mixtures of alkanes such as mineral oil.

A broad range of surfactants can be used, including: glycerol monocaprylate, glycerol monolaurate, glycerol mono/dicocoate, glycerol dilaurate, glycerol monostearate, glycerol monostearate distilled, glycerol distearate, glycerol monooleate, glycerol dioleate, glycerol trioleate, glycerol monoisostearate, glycerol monoricinoleate, glycerol monohydroxystearate, POE glycerol monostearate, acetylated glycerol monostearate, succinylated glycerol monostearate, diacetylated glycerol monostearate tartrate, modified glycerol phthalate resin, triglycerol monostearate, triglycerol monooleate, triglycerol monoisostearate, decaglycerol tetraoleate, decaglycerol decastearate, pentaerythritol monolaurate, pentaerythritol monostearate, pentaerythritol distearate, pentaerythritol tetrastearate, pentaerythritol monooleate, pentaerythritol dioleate, pentaerythritol trioleate, pentaerythritol tetraricinoleate, sorbitan monolaurate, POE sorbitan monolaurate, sorbitan monopalmitate, POE sorbitan monopalmitate, sorbitan monostearate, POE sorbitan monostearate, sorbitan tristearate, POE sorbitan tristearate, sorbitan monooleate, POE sorbitan monooleate, sorbitan sesquioleate, sorbitan trioleate, POE sorbitan trioleate, POE sorbitol hexaoleate, POE sorbitol oleate laurate, POE sorbitol polyoleate, POE sorbitol, beeswax-ester, sucrose monolaurate, sucrose cocoate, sucrose monomyristate, sucrose monopalmitate, sucrose dipalmitate, sucrose monostearate, sucrose distearate, sucrose monooleate, sucrose dioleate, lauryl lactate, cetyl lactate, sodium lauryl lactate, sodium stearoyl lactate, sodium isostearoyl-2-lactylate, sodium stearoyl-2-lactylate, calcium stearoyl-2-lactylate, sodium capryl lactate, lauryl alcohol, and cetyl alcohol.

In one embodiment the surfactant comprises at least one sorbitan ester. The sorbitan esters include sorbitan fatty acid esters wherein the fatty acid component of the ester comprises a carboxylic acid of about 10 to about 100 carbon atoms, and in one embodiment about 12 to about 24 carbon atoms. Sorbitan is a mixture of anhydrosorbitols, principally 1,4-sorbitan and isosorbide (Formulas I and II):

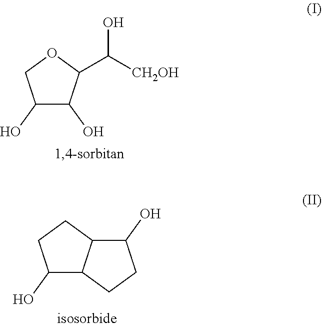 [SMILES: OCC(O)C1OCC(O)C1O ; OC1CCC2C(O)CCC12]

Sorbitan, (also known as monoanhydrosorbitol, or sorbitol anhydride) is a generic name for anhydrides derivable from sorbitol by removal of one molecule of water. The sorbitan fatty acid esters of this invention are a mixture of partial esters of sorbitol and its anhydrides with fatty acids. These sorbitan esters can be represented by the structure below which may be any one of a monoester, diester, triester, tetraester, or mixtures thereof (Formula III):

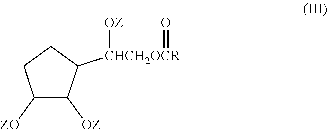

In formula (III), each Z independently denotes a hydrogen atom or C(O)R-, and each R mutually independently denotes a hydrocarbyl group of about 9 to about 99 carbon atoms, more preferably about 11 to about 23 carbon atoms. Examples of sorbitan esters include sorbitan stearates and sorbitan oleates, such as sorbitan stearate (i.e., monostearate), sorbitan distearate, sorbitan tristearate, sorbitan monooleate and sorbitan sesquioleate. The sorbitan esters also include polyoxyalkylene sorbitan esters wherein the alkylene group has about 2 to about 30 carbon atoms. These polyoxyalkylene sorbitan esters can be represented by Formula IV:

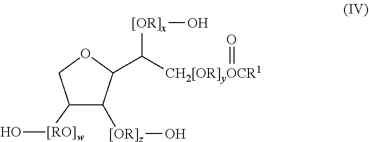

wherein in Formula IV, each R independently is an alkylene group of about 2 to about 30 carbon atoms; R′is a hydrocarbyl group of about 9 to about 99 carbon atoms, more preferably about 11 to about 23 carbon atoms; and w, x, y and z represent the number of repeat oxyalkylene units. For example, ethoxylation of sorbitan fatty acid esters leads to a series of more hydrophilic surfactants, which is the result of hydroxy groups of sorbitan reacting with ethylene oxide. One principal class of these ethoxylated sorbitan esters are those containing about 2 to about 80 ethylene oxide units, and in one embodiment from about 2 to about 30 ethylene oxide units, and in one embodiment about 4, in one embodiment about 5, and in one embodiment about 20 ethylene oxide units. Typical examples are polyoxyethylene (hereinafter “POE”) (20) sorbitan tristearate, POE (4) sorbitan monostearate, POE (20) sorbitan trioleate, POE (5) sorbitan monooleate, and POE (80) sorbitan monooleate. As used herein the number within the parentheses refers to the number of ethylene oxide units present in the composition.

Useful surfactants of the types listed in the above table can be generically represented by the following classes of chemical compounds, members of which are commercially available and are suitable provided that they are used in accordance with the teachings herein such that stable emulsions are produced:

(a) sorbitol esters of the general formula

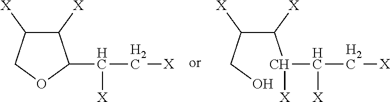

in which: the radicals X are identical to or different from one another and are each OH or R¹COO⁻;
where R¹ is a linear or branched, saturated or unsaturated, aliphatic hydrocarbon radical optionally substituted by hydroxyls and having from 7 to 22 carbon atoms, provided that at least one of said radicals X is R¹COO⁻,
(b) fatty acid esters of the general formula:

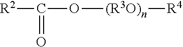

in which: R² is a linear or branched, saturated or unsaturated, aliphatic hydrocarbon radical optionally substituted by hydroxyl groups and having from 7 to 22 carbon atoms;
R³ is a linear or branched C₁-C₁₀ alkylene;
n is an integer greater than or equal to 6; and
R⁴ is H, linear or branched C₁-C₁₀ alkyl or

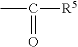

where R⁵ is as defined above for R²; and
(c) polyalkoxylated alkylphenol of the general formula

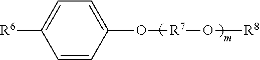

in which: R⁶ is a linear or branched C₁-C₂₀ alkyl;
m is an integer greater than or equal to 8; and
R⁷ and R⁸ are respectively as defined above for R³ and R⁴ of formula (II).

Typically, the weight ratio of sol to oil and surfactant mixture can be from about 1:5 to about 5:1, such as from about 1:4 to about 4:1, such as from about 1:3 to about 2:1, such as from about 1:2 to about 2:1. In some embodiments, the oil is a mineral oil and the surfactant is a sorbitan ester, such as a sorbitan monooleate and the weight ratio ranges from 1:2 to 2:1.

The temperature can be controlled during the emulsion forming step in order to obtain the desired silica sol droplet size. For example, the temperature can be maintained above about 30° C., such as from about 40° C. to about 80° C., such as from about 50° C. to about 65° C., while forming the emulsion.

The mixing speed should be sufficiently high to form a stable emulsion, i.e., an emulsion that does not separate upon standing at room temperature within a desired period of time, and to obtain the desired silica sol droplet size. Such mixing speed may be accomplished using an overhead type mixer, e.g., a DISPERMAT® mixer, or an in-line type mixer, e.g., SILVERSON® mixer. After the sol is fully pumped into the reaction vessel or otherwise fully mixed, the emulsion can be continually mixed for a time period sufficient to maintain a stable emulsion. For example, in some embodiments, mixing can continue for a time period from about 1 min to about an hour.

Following the formation of the emulsion, the process proceeds to step 103 in which the pH of the emulsion is optionally adjusted. The pH can be adjusted using a basic compound. For example, any base known or hereafter discovered can be employed in the various embodiments described herein for adjusting the pH. In various embodiments, the base can be selected from the group consisting of NaOH, aqueous ammonia, ammonium hydroxides (e.g., NH₄OH), KOH, Na₂CO₃, TMAOH, NaAlO₂, and mixtures thereof. Additionally, the base employed can be in the form of a solution having a concentration in the range of from 0.2 to 50 percent. In various embodiments, the above-mentioned base can have a pH of at least 7, such as from about 8 to about 14, such as from about 9 to about 13. The amount of the basic compound used is determined by the target pH to be reached. For example, in some embodiments, the basic compound is added until the pH reaches a value of about 3 or greater, in some embodiments about 4 or greater, in some embodiments about 5 or greater, in some embodiments about 6 or greater, in some embodiments about 7 or greater, and in some embodiments, about 8 or greater. The pH typically reaches about 12 or less, in some embodiments about 11 or less, in some embodiments about 10 or less, and in some embodiments, about 9 or less. For instance, in some embodiments, ammonium hydroxide is added until the pH reaches from about 3 to about 10, such as from about 5 to about 9. The emulsion can be continuously mixed as the basic compound is added and for a short period of time thereafter to promote pH stabilization. The mixing speed can optionally be reduced at this stage. For example, in some embodiments, the mixing speed is reduced to a speed from about 10% to about 60% of the mixing speed used to form the emulsion.

It should be understood that the pH is not necessarily adjusted, and that step 103 is optional. The pore properties of the resulting silica particles can be controlled by adjusting the pH of the emulsion during gelation. As such, the pH should be adjusted to the level necessary to obtain the desired pore properties. Thus, in some instances, the pH will not need to be adjusted at all.

Following the optional pH adjusting step, the process can proceed to step 104 in which the silica is gelled. The gelling process can comprise optionally adding water into the emulsion and increasing the temperature while optionally continuously mixing. The volume of water added at this stage is not critical but can be from about 0.25 to about 10 times the volume of the mixture within the vessel. In other embodiments, no water is added.

The temperature for gelling can range from about 50°° C. to about 95° C., in some embodiments from about 70°° C. to about 90° C., and in some embodiments, from about 75° C. to about 85° C. The mixing speed can be maintained at a similar speed as in step 103. This temperature and mixing speed can be maintained for a period of time sufficient to allow the silica to gel. For example, in some embodiments, the gelling time can be from about 20 min to about 2 hours, such as from about 30 min to about 90 min.

In some embodiments, the obtained silica gel can be aged prior to separation. In this case, the obtained silica gel is maintained at a temperature from about 50° C. to about 95° C., in some embodiments from about 70° C. to about 90° C., and in some embodiments, from about 75° C. to about 85° C. for a time period from about 10 minutes to about 10 hours, in some embodiments from about 30 minutes to about 5 hours, and in some embodiments, from about 45 minutes to about 2 hours. The pH can optionally be adjusted during the aging process. In this manner, the surface area and pore diameter can be adjusted in situ and the gel network can be strengthened.

Following the gelling step, the process can proceed to separation in step 105. Any suitable method can be used to separate the solid silica gel particles from the oil and water phases of the mixture. For example, in some embodiments, the mixing is discontinued so that the oil and surfactant separate from the formed silica particles. In some embodiments, the solid particles can be filtered out of the mixture.

The obtained silica particles can then optionally be washed in step 106, for example by stirring them in an acid, water, and/or alcohol. The particles can then be dried in step 107 using any suitable method. For example, in some embodiments, the particles can be dried at a temperature and time sufficient to remove the desired amount of moisture. In some embodiments, the particles can be dried in a vacuum oven at a temperature from about 40° C. to about 80° C. for about 30 minutes to 24 hours. In some embodiments, the particles can be dried in a conventional oven at a temperature from about 90°° C. to about 130°° C. for about 30 minutes to about 24 hours. In some embodiments, the particles can be dried using spray dryer. In other embodiments, the particles can be dried by flash drying or by co-evaporation using an organic solvent.

In some embodiments, to facilitate the separation of the oil and surfactant from the emulsion, the emulsion is demulsified by adding a demulsifying agent. In some embodiments, the demulsifying agent is water or an acid, such as a mineral acid. For example, in some embodiments, deionized water or aqueous mineral acid is added to the emulsion as a demulsifying agent. For example, when aqueous sulfuric acid composition is employed as a demulsifier, the concentration of the sulfuric acid can be from about 1 wt. % to about 30 wt. %, in some embodiments from about 5 wt. % to about 15 wt. % of the total aqueous composition. The demulsifying agent can be added to the emulsion in a weight ratio from about 1:5 to about 5:1 relative to the weight of the emulsion, in some embodiments in a weight ratio from about 1:2 to about 1:1.

The demulsification can occur at an elevated temperature. For example, the temperature can be from about 50°° C. to about 95° C., in some embodiments from about 60° C. to about 90° C., and in some embodiments, from about 70° C. to about 80° C. During demulsification, the mixture can optionally by agitated by any suitable means. For example, in some embodiments, after the demulsifying agent is added, the mixture is agitated at an elevated temperature for about 30 minutes to about 5 hours, such as from about 1 hour to about 3 hours. In other embodiments, the mixture is kept at an elevated temperature without agitation for about 30 minutes to about 5 hours, such as from about 1 hour to about 3 hours.

Following demulsification, the particles can be separated from the rest of the mixture by any suitable means. For example, in some embodiments, the mixture can be transferred to a separatory funnel to separate the aqueous phase from the oil phase. The silica particles can then be separated from the rest of the liquid. In some embodiments, for example, the particles can be filtered and redispersed repeatedly as necessary.

After separation, the particles can optionally be aged as shown in FIG. 1, step 106a. The particles can be aged at an elevated temperature in an ammonia solution. In some embodiments, the particles are redispersed in an aqueous medium, heated, and combined with ammonium hydroxide for a suitable time period. The pH of the redispersed particles in the aqueous medium can be from about 1 to about 5, such as from about 2 to about 4. The temperature for aging can be from about 50° C. to about 95° C., in some embodiments from about 70°° C. to about 90° C., and in some embodiments, from about 75° C. to about 85° C. Ammonium hydroxide can be added until the pH of the solution reaches from about 6 to about 9, such as from about 7 to about 8. In some embodiments, the particles are aged for a time period from about 10 minutes to about 10 hours, in some embodiments from about 30 minutes to about 5 hours, and in some embodiments, from about 45 minutes to about 2 hours.

If the particles are aged in such a solution, they can be filtered and dried afterward. For example, in some embodiments the particles can be filtered from the ammonia solution, redispersed in water as necessary, and then filtered and dried to remove water and any solvent to form a powder. In some embodiments, after being filtered from the ammonia solution, the particles are redispersed in deionized water and then dried at an elevated temperature for a suitable time period. Any suitable temperature can be used to dry the particles. In some embodiments, for example, the particles are dried at a temperature from about 50°° C. to about 250° C., in some embodiments from about 80°° C. to about 200°° C., and in some embodiments, from about 100°° C. to about 150° C. for a time period from about 1 hour to about 48 hours, such as from about 5 hours to about 24 hours, although the time and temperature are not critical.

The emulsion process used to form the porous silica particles can provide additional advantages over conventional processes. For instance, in conventional processes for producing porous silica gel particles having a desired particle size, milling step is typically employed. This milling step tends to produce very small silica particles, known as “fines.” However, advantageously, the process disclosed herein produces particles having the desired particle size and no milling is required.

During the above process, the silica gel particles form within the droplets of the emulsion to provide porous spherical silica particles. Each particle contains a rigid network of amorphous silica. As such, the particles tend to be highly spherical. One method for measuring the sphericity of particles is to take an image of a number of particles and calculate the aspect ratio of each particle using the largest diameter and the smallest diameter of each particle that can be determined from the image. Then, an average aspect ratio of the particles can be calculated using the aspect ratios of the individual particles. Aspect ratio is an indication of sphericity. Particles having a low aspect ratio are more spherical than particles having a higher aspect ratio. In this regard, the particles formed by either of the above processes are highly spherical and can have a low average aspect ratio, such as about 1.2 or less, in some embodiments about 1.17 or less, in some embodiments about 1.15 or less, in some embodiments about 1.12 or less, and in some embodiments, about 1.1 or less. For example, in some embodiments, at least 75% of the particles have an aspect ratio of about 1.2 or less, such as about 1.1 or less. In some embodiments, at least 50% of the particles have an aspect ratio of about 1.1 or less. The aspect ratio is typically about 1.0 or greater.

As explained above, the highly spherical porous silica particles can be used in a variety of different applications. For example, the silica particles can be used as catalyst supports, insulating materials, toners, food additives, medical diagnostic agents, paint fillers, cosmetic fillers, resin fillers, chromatography media, adsorbents, desiccants, and the like.

The present disclosure may be better understood with reference to the following examples.

### EXAMPLES

### Test Methods

The surface area, pore volume and average pore diameter were measured by nitrogen adsorption. The instrument used for the analysis is an autosorb iQ2 TPX from Quantachrome Instrument. The nitrogen adsorption method is known as BET and is described in S. Brunauer, P. H. Emmett and E. Teller, J. Am. Chem. Soc., 1938, 60, 309.

The samples were activated under vacuum at 400° C. temperature for 30 minutes prior to analysis. Surface areas were calculated from multi-point values of the nitrogen volumetric uptake during the adsorption branch at low [P/Po=˜0.05 to 0.15] partial pressures. The adsorption branch of the isotherm was stopped at a partial pressure of P/Po=0.995 and then the descending branch of the isotherm was measured. The pore volumes were calculated by applying the Gurvich rule at P/Po=0.995. Pore diameters are reported as calculated BJH desorption average diameter.

The silica gels of this invention are typical mesoporous materials (pore size 2-50 nm, IUPAC definition), and they typically display type IV isotherms (IUPAC classification). Thus, nitrogen porosimetry is an appropriate method for their characterization, and the determination of surface area using the BET method and pore volume using the BJH method from nitrogen adsorption and desorption isotherms are well established and appropriate methods and are used herein.

The mean particle size (D50) and particle size distribution were measured by using a Malvern 3000 particle size analyzer apparatus from Brightwell Technologies Inc., after sonication for 2 minutes. The measurements were made using a refractive index of 1.49.

Aspect ratio was determined from SEM micrographs using Image-Pro Premier software. For each particle in a sample image, the aspect ratio was calculated by dividing the longest diameter by the shortest diameter. The aspect ratios of the individual particles of each sample were then averaged to determine the average aspect ratio of the particles within the sample. For each sample for which an aspect ratio is provided, about 150 particles were used for the calculation.

### Example 1

An emulsion process was used to obtain a porous spherical silica material. First, sodium silicate and a mineral acid were reacted to make a sol. The sol was made at a temperature of 15° C. and a pH 1.5 by adding 2829 g of sodium silicate (14 wt. %) into 850 g of acid (25 wt. % H₂SO₄) at a flow rate of 150 ml/min and mixing at 500 rpm for 10 min using a DISPERMAT® overhead mixture. 3500 g of sol was mixed with mineral oil (3500 g) and surfactant (sorbitan monooleate, 245 g). The emulsion was made by continuously passing the mixture through a SILVERSON® inline mixer with the flow of 3.5 L/min at a speed of 1500 rpm for 1 min. The pH was adjusted to 5.5 by adding ammonium hydroxide into the emulsion to control the gelling process. The temperature was then increased to 60°° C. and aged for 1 h at 60°° C. 3000 g of 5 wt. % sulfuric acid was then added to demulsify the mixture at 250 rpm at 60° C. for 1 hour. After the demulsification, the mixture was cooled, and the oil phase was allowed to separate from the water phase. The water phase containing the silica particles was collected and the silica particles were filtered from the water phase. The silica particles were repeatedly washed using water at 50° C. by reslurrying the particles in water. This process was continued until the pH of slurry reached 4. Then, the particles were thereafter dried with spray dryer. The obtained particles were spherical porous silica and had a D50 particle size of 20 μm and a span of 1.4. The BET surface area of the obtained particles was 618 m²/g, the pore volume was 1.4 ml/g, and the average pore diameter was about 89 Å. An image of the particles is shown in FIG. 2. The average aspect ratio is 1.08. The properties of the resulting silica particles are summarized in Table 1 below.

### Example 2

An emulsion process was used to obtain a porous spherical silica material. First, sodium silicate and a mineral acid were reacted to make a sol. The sol was made at a temperature of 15° C. and a pH 1.5 by adding 2869 g of sodium silicate (14 wt. %) into 850 g of acid (25 wt. % H₂SO₄) at a flow rate of 200 ml/min and mixing at 500 rpm for 10 min using a DISPERMAT® overhead mixer. 3500 g of sol was mixed with mineral oil (3500 g) and surfactant (sorbitan monooleate, 245 g). The emulsion was made by continuously passing the mixture through a SILVERSON® inline mixer with the flow of 3.5 L/min at a speed of 1250 rpm for 1.5 min. The pH was adjusted to 6 by adding ammonium hydroxide into the emulsion to control the gelling process. The temperature was then increased to 60° C. and aged for 1 h at 60°° C. 3000 g of 5 wt. % sulfuric acid was then added to demulsify the mixture at 250 rpm at 60° C. for 1 hour. After the demulsification, the mixture was cooled, and the oil phase was allowed to separate from the water phase. The water phase containing the silica particles was collected and the silica particles were filtered from the water phase. The silica particles were repeatedly washed using water at 50° C. by reslurrying the particles in water. This process was continued until the pH of slurry reached 4. Then, the particles were thereafter dried with spray dryer. The obtained particles were spherical porous silica and had a D50 particle size of 35 μm and a span of 1.5. The BET surface area of the obtained particles was 551 m²/g, the pore volume was 1.3 ml/g, and the average pore diameter was about 97 Å. An image of the particles is shown in FIG. 3. The average aspect ratio is 1.1. The properties of the resulting silica particles are summarized in Table 1 below.

### Example 3

An emulsion process was used to obtain a porous spherical silica material. First, sodium silicate and a mineral acid were reacted to make a sol. The sol was made at a temperature of 15° C. and a pH 1.5 by adding 200 g of sodium silicate (14 wt. %) into 53 g of acid (18.5% HCl) at a flow rate of 10 ml/min and mixing at 960 rpm for 20 min using an overhead mixer. The sol was then pumped to mineral oil (300 g) and surfactant (sorbitan monooleate, 15 g) mixture. The emulsion was made by continuously mixing the mixture at a speed of 960 rpm at a temperature (60° C.) for 10 min using an overhead mixer. The pH was adjusted by adding 2.9 g of ammonium hydroxide into the emulsion to control the gelling process. The emulsion was then mixed at 250 rpm for 5 min. 400 ml water was added to the emulsion. The temperature was then increased to 80°° C. The emulsion was mixed at 250 rpm for 1 h for gelation. After the gelation, the mixture was cooled for 30 min and the oil phase was allowed to separate from the water phase. The water phase containing the silica particles was collected and the silica particles were filtered from the water phase. The silica particles were washed using 200 ml of water at pH of 4 at 60°° C. while mixing at 250 rpm for 40 min, and then filtered. The washing step was repeated two more times. Then, the particles were washed with isopropanol before drying in a vacuum oven at 60° C. for 1 h. The obtained particles were spherical porous silica and had a D50 particle size of 14 μm and a span of 1.5. The BET surface area of the obtained particles was 456 m²/g, the pore volume was 1.5 ml/g, and the average pore diameter was about 101 Å. An image of the particles is shown in FIG. 4. The properties of the resulting silica particles are summarized in Table 1 below.

### Example 4

An emulsion process was used to obtain a porous spherical silica material. First, sodium silicate and a mineral acid were reacted to make a sol. The sol was made at a temperature of 15° C. and a pH 1.5 by adding 253 g of sodium silicate (14 wt. %) into 50.5 g of acid (18.5% HCl) at a flow rate of 10 ml/min and mixing at 960 rpm for 20 min using an overhead mixer. The sol was then pumped into oil (150 g) and surfactant (sorbitan monooleate, 10 g) mixture. The emulsion was made by continuously mixing the mixture at a speed of 960 rpm at a stable temperature (60° C.) for 10 min using an overhead mixer. The pH was adjusted by adding 2.4 g of ammonium hydroxide into the emulsion to control the gelling process. The emulsion was then mixed at 250 rpm for 5 min. 400 ml water was added to the emulsion. The temperature was then increased to 80°° C. The emulsion was mixed at 250 rpm for 1 h for gelation. After the gelation, the mixture was cooled for 30 min and the oil phase was allowed to separate from the water phase. The water phase containing the silica particles was collected and the silica particles were filtered from the water phase. The silica particles were washed using 200 ml of water at pH 4 at 60° C. while mixing at 250 rpm for 40 min, and then filtered. The washing step was repeated two more times. Then, the particles were washed with isopropanol before drying in a vacuum oven at 60° C. for 1 h. The obtained particles were spherical porous silica and had a D50 particle size of 17 μm and a span of 1.3.

The BET surface area of the obtained particles was 917 m²/g, the pore volume was 1.9 ml/g, and the average pore diameter was about 101 Å. An image of the particles is shown in FIG. 5. The properties of the resulting silica particles are summarized in Table 1 below.

### Example 5

An emulsion process was used to obtain a porous spherical silica material. First, sodium silicate and a mineral acid were reacted to make a sol. The sol was made at a temperature of 15° C. and a pH 1.5 by adding 201 g of sodium silicate (14 wt. %) into 53.5 g of acid (18.5% HCl) at a flow rate of 10 ml/min and mixing at 960 rpm for 20 min using an overhead mixer. The sol was then pumped into oil (91 g) and surfactant (sorbitan monooleate, 7.7 g) mixture. The emulsion was made by continuously mixing the mixture at a speed of 960 rpm at a stable temperature (60°° C.) for 10 min using an overhead mixer. The pH was adjusted by adding 1.0 g of ammonium hydroxide into the emulsion to control the gelling process. The emulsion was mixed for 5 more min at 250 rpm. 400 ml water was added to the emulsion. The temperature was then increased to 80°° C. The emulsion was mixed at 250 rpm for 1 h for gelation. After the gelation, the mixture was cooled for 30 min and the oil phase was allowed to separate from the water phase. The water phase containing the silica particles was collected and the silica particles were filtered from the water phase. The silica particles were washed using 200 ml of water at pH 4 at 60° C. while mixing at 250 rpm for 40 min, and then filtered. The washing step was repeated two more times. Then, the particles were washed with isopropanol before drying in a vacuum oven at 60° C. for 1 h. The obtained particles were spherical porous silica and had a D50 particle size of 9 μm and a span of 1.1. The BET surface area of the obtained particles was 505 m²/g, the pore volume was 2.5 ml/g, and the average pore diameter was about 189 Å. An image of the particles is shown in FIG. 6. The properties of the resulting silica particles are summarized in Table 1 below.

### Example 6

An emulsion process was used to obtain a porous spherical silica material. First, sodium silicate and a mineral acid were reacted to make a sol. The sol was made at a temperature of 15° C. and a pH 1.5 by adding 805 g of sodium silicate (22.5 wt. %) into 455 g of acid (25 wt. % H₂SO₄) at a flow rate of 80 ml/min and mixing at 500 rpm for 10 min using a DISPERMAT® overhead mixer. 1000 g of sol was mixed with mineral oil (370 g) and surfactant (sorbitan monooleate, 25 g). The emulsion was made by continuously mixing at a speed of 1500 rpm for 30 min using DISPERMAT® overhead mixer. The pH was adjusted to 3.5 by adding ammonium hydroxide into the emulsion to control the gelling process. The temperature was then increased to 70° C. and mixed for 1 h at 70° C. 2000 g of 10 wt. % sulfuric acid was then added to demulsify the mixture at 250 rpm at 70° C. for 30 min. After the demulsification, the mixture was cooled, and the oil phase was allowed to separate from the water phase. The water phase containing the silica particles was collected and the silica particles were filtered from the water phase. The silica particles were repeatedly washed using 1500 g water at 50° C. by reslurrying the particles in water. This process was repeated three times. Then, the alternative aging step (106a) was followed to control the pore volume. The particles were redispersed in water at pH 3, and then ammonia was added to adjust pH to 7.6 at 70° C. for aging. After aging for 1 hour, the particles were separated and washed with water at pH, and then were collected after filtration. The particles were then dried in an oven at 130° C. for 10 hours. The obtained particles were spherical porous silica and had a D50 particle size of 3.8 μm and a span of 0.9. The BET surface area of the obtained particles was 526 m²/g, the pore volume was 2.1 ml/g, and the average pore diameter was about 151 Å. An image of the particles is shown in FIG. 7. The average aspect ratio is 1.03. The properties of the resulting silica particles are summarized in Table 1 below.

### Example 7

An emulsion process was used to obtain a porous silica material. First, sodium silicate and acid were reacted to make a sol before adding the sol to oil and surfactant to generate an emulsion. The sol was made at a controlled temperature (≤25° C.) and pH (≤1.5) by adding 2233 g of sodium silicate (14%) into the acid (700 g, 25 wt. % sulfuric acid) at a flow rate of 150 ml/min and mixing at 500 rpm for 10 min. 2000 g of sol was mixed with mineral oil (850 g) and surfactant (sorbitan monooleate, 50 g). The emulsion was made by continuously mixing at a speed of 1200 rpm for 15 min using a DISPERMAT® overhead mixer. pH of emulsion was adjusted to 3.5 by adding ammonium hydroxide into the emulsion to enhance the gelation. The emulsion was heated to 70° C., and then mixed at 250 rpm for 1 h. After the reaction, 3000 g of 10 wt. % sulfuric acid was added to the emulsion and mixed for 30 min at 80° C. for two hours for demulsification. The mixture was left for 30 min to let the oil and surfactant separate from the obtained silica particles. The mixture was then filtered to separate the oil and surfactant from the silica particles. The silica particles were then washed with 1500 g water for three times. The alternate aging step (106a) was conducted to control pore volume. The particles were redispersed in water at pH 3, and then ammonia was added to adjust pH to 7-8 at 70°° C. for aging. After aging, the particles were separated and redispersed at pH 4, and then were collected after filtration. The wet particles were dried in an oven at 130°° C. for 10 hours. The obtained particles had an a D50 particle size of 6.7 μm and a span of 1.4. The average BET surface area of the obtained particles was 652 m²/g, the average pore volume was 1.2 ml/g, and the average pore diameter was about 94 Å. An image of the particles is shown in FIG. 8. The average aspect ratio is 1.07. The properties of the resulting silica particles are summarized in Table 1 below.

### Example 8

An emulsion process was used to obtain a porous silica material. First, sodium silicate and acid were reacted to make a sol before adding the sol to oil and surfactant to generate an emulsion. The sol was made at a controlled temperature (≤25° C.) and pH (≤1.5) by adding 3086 g of sodium silicate (14%) into the acid (700 g, 25 wt. % sulfuric acid) at a flow rate of 100 ml/min and mixing at 500 rpm for 10 min. 2000 g of sol was mixed with mineral oil (900 g) and surfactant (sorbitan monooleate, 50 g). The emulsion was made by continuously mixing at a speed of 1000 rpm for 30 min using a DISPERMAT® overhead mixer. pH of emulsion was adjusted to 3 by adding ammonium hydroxide into the emulsion to enhance the gelation. The emulsion was heated to 70°° C., and then mixed at 250 rpm for 1 h. After the reaction, 3000 g of 10 wt. % sulfuric acid was added to the emulsion and mixed for 30 min at 80°° C. for two hours for demulsification. The mixture was left for 30 min to let the oil and surfactant separate from the obtained silica particles. The mixture was then filtered to separate the oil and surfactant from the silica particles. The silica particles were then washed with 1500 g water for three times. The alternate aging step (106a) was conducted to control pore volume. The particles were redispersed in water at pH 3, and then ammonia was added to adjust pH to 7-8 at 70°° C. for aging. After aging, the particles were separated and redispersed at pH 4, and then were collected after filtration. The wet particles were dried in an oven at 130° C. for 10 hours. The obtained particles had a D50 particle size of 38 μm and a span of 1.7. The average BET surface area of the obtained particles was 549 m²/g, the average pore volume was 1.0 ml/g, and the average pore diameter was about 110 Å. An image of the particles is shown in FIG. 9. The average aspect ratio is 1.1. The properties of the resulting silica particles are summarized in Table 1 below.

### Example 9

An emulsion process was used to obtain a porous silica material. First, sodium silicate and acid were reacted to make a sol before adding the sol to oil and surfactant to generate an emulsion. The sol was made at a controlled temperature (≤25° C.) and pH (≤1.5) by adding 2411 g of sodium silicate (14%) into the acid (700 g, 25 wt. % sulfuric acid) at a flow rate of 100 ml/min and mixing at 500 rpm for 10 min. 2000 g of sol was mixed with mineral oil (750 g) and surfactant (sorbitan monooleate, 50 g). The emulsion was made by continuously mixing at a speed of 1200 rpm for 30 min using a DISPERMAT® overhead mixer. The emulsion was heated to 70°° C., and then mixed at 250 rpm for 1 h. After the reaction, 3000 g of 10 wt. % sulfuric acid was then added to demulsify the mixture at 250 rpm at 80° C. for 2 hours. After the demulsification, the mixture was cooled, and the oil phase was allowed to separate from the water phase. The water phase containing the silica particles was collected and the silica particles were filtered from the water phase. The silica particles were repeatedly washed using water at 50° C. by reslurrying the particles in 1500 g water. This process was repeated three times. Then, the particles were thereafter dried in an oven at 130°° C. for 10 hours. The obtained particles were spherical porous silica and had a D50 particle size of 30 μm and a span of 1.7. The BET surface area of the obtained particles was 750 m²/g, the pore volume was 0.5 ml/g, and the average pore diameter was about 33 Å. An image of the particles is shown in FIG. 10. The average aspect ratio is 1.11. The properties of the resulting silica particles are summarized in Table 1 below.

Table 1 summarizes the properties of the silica particles produced in Examples

1-9.

TABLE 1

| | D50 | | BET | Pore Volume | Pore |
|---|---|---|---|---|---|
| Example | [μm] | Span | [m²/g] | [cc/g] | Diameter [Å] |
| 1 | 20 | 1.4 | 618 | 1.4 | 89 |
| 2 | 35 | 1.5 | 551 | 1.3 | 97 |
| 3 | 14 | 1.5 | 456 | 1.5 | 101 |
| 4 | 17 | 1.3 | 917 | 1.9 | 101 |
| 5 | 9 | 1.1 | 505 | 2.5 | 189 |
| 6 | 3.8 | 0.9 | 526 | 2.1 | 151 |
| 7 | 6.7 | 1.4 | 652 | 1.2 | 94 |
| 8 | 38 | 1.7 | 549 | 1.0 | 110 |
| 9 | 30 | 1.7 | 750 | 0.5 | 33 |

### CERTAIN EMBODIMENTS

Embodiment 1. A process for forming a porous spherical silica, the process comprising:
a. mixing an alkali silicate with a mineral acid at pH and a temperature sufficient to form a silica sol,
b. mixing the silica sol with an oil and a surfactant to form an emulsion,
c. adding an alkaline solution to the emulsion at a time and temperature sufficient to form a gel,
d. adding a demulsifying agent and heating at a temperature sufficient to separate porous spherical silica particles from the oil,
e. washing and optionally aging the particles, and
f. drying the porous spherical silica particles.

Embodiment 2. The process of Embodiment 1, wherein the alkali silicate is sodium silicate.

Embodiment 3. The process of Embodiment 1 or Embodiment 2, wherein the mineral acid is sulfuric acid or hydrochloric acid.

Embodiment 4. The process of any one of Embodiments 1-3, wherein the oil comprises mineral oil.

Embodiment 5. The process of any one of Embodiments 1-4, wherein the surfactant comprises a nonionic surfactant.

Embodiment 6. The process of Embodiment 5, wherein the surfactant comprises a sorbitan ester.

Embodiment 7. The process of Embodiment 6, wherein the surfactant comprises a sorbitan oleate.

Embodiment 8. The process of any one of Embodiments 1-7, wherein the alkaline solution comprises ammonium hydroxide.

Embodiment 9. The process of any one of Embodiments 1-8, wherein the emulsion is maintained at a temperature of from about 40° C. to about 90°° C. for about 0.25 to about 2 hours prior to adding the demulsifying agent.

Embodiment 10. The process of any one of Embodiments 1-9, wherein the alkaline solution is added until the pH reaches a level of from about 5 to about 10.

Embodiment 11. The process of Embodiment 10, wherein the alkaline solution is added until the pH reaches a level of from about 6 to about 9.

Embodiment 12. The process of any one of Embodiments 1-11, wherein the silica sol is formed at a temperature less than 25° C.

Embodiment 13. The process of any one of Embodiments 1-12, wherein the particles are aged after washing prior to drying.

Embodiment 14. The process of Embodiment 13, wherein the particles are aged at a pH from about 7 to about 9 at a temperature from about 60° C. to about 90° C. for a time period of about 1 to about 4 hours.

Embodiment 15. The process of any one of Embodiments 1-14, wherein the emulsion is formed by mixing the silica sol with a mixture comprising oil and surfactant.

Embodiment 16. The process of Embodiment 15, wherein the concentration of surfactant in the surfactant/oil mixture ranges from about 3 wt. percent to about 25 wt. percent of the mixture.

Embodiment 17. The process of Embodiment 15, wherein the concentration of surfactant in the surfactant/oil mixture ranges from about 4 wt. percent to about 15 wt. percent of the mixture.

Embodiment 18. The process of Embodiment 15, wherein the concentration of surfactant in the surfactant/oil mixture ranges from about 5 wt. percent to about 8 wt. percent of the mixture.

Embodiment 19. The process of any one of Embodiments 1-18, wherein the ratio of silica sol to the surfactant/oil mixture ranges from about 1:5 to about 5:1.

Embodiment 20. The process of any one of Embodiments 1-19, wherein the ratio of silica sol to the surfactant/oil mixture ranges from about 1:3 to about 4:1.

Embodiment 21. The process of any one of Embodiments 1-20, wherein the ratio of silica sol to the surfactant/oil mixture ranges from about 1:2 to about 2:1.

Embodiment 22. The process of any one of Embodiments 1-21, wherein the demulsifying agent comprises a mineral acid.

Embodiment 23. A silica material formed by the process of any one of Embodiments 1-22, the silica material comprising: a plurality of single silica gel particles, each particle comprising an amorphous network, the particles having an average aspect ratio of about 1.2 or less, a pore volume of from about 0.5 cc/g to about 2.5 cc/g, a surface area from about 300 m²/g to about 800 m²/g; and a median particle size from about 3 μm to about 40 μm.

Embodiment 24. A silica material formed by the process of Embodiments 1-22, the silica material comprising:
a plurality of single silica gel particles, each particle comprising an amorphous network, the particles having an average aspect ratio of about 1.2 or less, a pore volume of from about 0.8 cc/g to about 2.0 cc/g, a surface area from about 400 m²/g to about 700 m²/g; and a median particle size from about 8 μm to about 40 μm.

Embodiment 25. The silica material of Embodiment 23 or Embodiment 24, wherein the silica particles have a span of about 2.0 or less.

Embodiment 26. The silica material of Embodiment 23 or Embodiment 24, wherein the silica particles have an average pore size of from about 30 to about 250 Angstrom.

1. A process for forming a porous spherical silica, the process comprising:
a. mixing an alkali silicate with a mineral acid at pH and a temperature sufficient to form a silica sol,
b. mixing the silica sol with an oil and a surfactant to form an emulsion,
c. adding an alkaline solution to the emulsion at a time and temperature sufficient to form a gel,
d. adding a demulsifying agent and heating at a temperature sufficient to separate porous spherical silica particles from the oil,
e. washing and optionally aging the particles, and
f. drying the porous spherical silica particles.

2. The process of claim 1, wherein the alkali silicate is sodium silicate.

3. The process of claim 1, wherein the mineral acid is sulfuric acid or hydrochloric acid.

4. The process of claim 1, wherein the oil comprises mineral oil.

5. The process of claim 1, wherein the surfactant comprises a nonionic surfactant.

6. The process of claim 5, wherein the nonionic surfactant comprises a sorbitan ester.

7. (canceled)

8. The process of claim 1, wherein the alkaline solution comprises ammonium hydroxide.

9. The process of claim 1, wherein the emulsion is maintained at a temperature of from about 40°° C. to about 90° C. for about 0.25 to about 2 hours prior to adding the demulsifying agent.

10. The process of claim 1, wherein the alkaline solution is added until the pH reaches a level of from about 5 to about 10.

11. (canceled)

12. The process of claim 1, wherein the silica sol is formed at a temperature less than 25° C.

13. The process of claims 1, wherein the particles are aged after washing prior to drying.

14. The process of claim 13, wherein the particles are aged at a pH from about 7 to about 9 at a temperature from about 60°° C. to about 90° C. for a time period of about 1 to about 4 hours.

15. The process of claim 1, wherein the emulsion is formed by mixing the silica sol with a mixture comprising oil and surfactant.

16. The process of claim 15, wherein the concentration of surfactant in the surfactant/oil mixture ranges from about 3 wt. percent to about 25 wt. percent of the mixture.

17. (canceled)

18. (canceled)

19. The process of claim 1, wherein the ratio of silica sol to the surfactant/oil mixture ranges from about 1:5 to about 5:1.

20. (canceled)

21. (canceled)

22. The process of claim 1, wherein the demulsifying agent comprises a mineral acid.

23. A silica material formed by the process of claim 1, the silica material comprising:
a plurality of single silica gel particles, each particle comprising an amorphous network, the particles having an average aspect ratio of about 1.2 or less, a pore volume of from about 0.5 cc/g to about 2.5 cc/g, a surface area from about 300 m2/g to about 800 m2/g; and a median particle size from about 3 μm to about 40 μm.

24. A silica material formed by the process of claim 1, the silica material comprising:
a plurality of single silica gel particles, each particle comprising an amorphous network, the particles having an average aspect ratio of about 1.2 or less, a pore volume of from about 0.8 cc/g to about 2.0 cc/g, a surface area from about 400 m²/g to about 700 m²/g; and a median particle size from about 8 μm to about 40 μm.

25. The silica material of claim 23, wherein the silica particles have a span of about 2.0 or less and/or wherein the silica particles have an average pore size of from about 30 to about 250 Angstrom.

26. The silica material of claim 24, wherein the silica particles have a span of about 2.0 or less and/or wherein the silica particles have an average pore size of from about 30 to about 250 Angstrom.
